(19) United States
(12) Patent Application Publication
(10) Pub. No.: US 2023/0038495 A1
(43) Pub. Date: Feb. 9, 2023

(54) TRANSMISSION UNIT AND LIDAR DEVICE INCLUDING IMPROVED OPTICAL EFFICIENCY

(71) Applicant: Robert Bosch GmbH, Stuttgart (DE)

(72) Inventors: Andre Albuquerque, Penalva do Castelo (PT); Anne Schumann, Korntal-Muenchingen (DE); Dionisio Pereira, Avintes (PT); Markus Hippler, Stuttgart (DE); Maximilian Amberger, Karlsruhe (DE); Stefan Spiessberger, Weinstadt (DE); Albert Groening, Stuttgart (DE)

(21) Appl. No.: 17/789,927

(22) PCT Filed: Jan. 11, 2021
(86) PCT No.: PCT/EP2021/050333

§ 371 Date: Jun. 29, 2022

(30) Foreign Application Priority Data
Jan. 30, 2020 (DE) 10 2020 201 118.4

(51) Int. Cl. G01S 7/481; G02B 27/30; G02B 27/09

(52) U.S. Cl. CPC G01S 7/4817; G02B 27/30; G01S 7/4814; G02B 27/0922; G02B 27/0927; G02B 27/0988

(57) ABSTRACT

A transmission unit for a LIDAR device for emitting collimated beams into a scanning area. The transmission unit includes at least one beam source for generating beams in the form of a beam bundle, the beam source being designed as a surface emitter or an emitter array, and a transmission optical unit including at least one lens. The transmission unit includes a diaphragm including at least one aperture, which is configured to delimit a cross section of the beam bundle of the generated beams in a horizontal direction and/or a vertical direction. The at least one lens of the transmission optical unit is situated downstream from the diaphragm in the emission direction of the beams. A LIDAR device is also described.

### FIELD

The present invention relates to a transmission unit, in particular for a LIDAR device, for emitting collimated beams in a scanning area, including at least one beam source for generating beams in the form of a beam bundle, the beam source being designed as a surface emitter or an emitter array, and including a transmission optical unit including at least one lens. Furthermore, the present invention relates to a LIDAR device having a transmission unit.

### BACKGROUND INFORMATION

The beam propagation of a laser beam may be described by the beam parameter product. The beam parameter product is a function of the diffraction index, which is inversely proportional to the beam quality.

The diffraction index of a beam source becomes greater the greater the emission diameter or the beam waist diameter is, at equal divergence of the generated beams. This relationship has the result that beam sources having large emission diameters, for example, surface emitters, may not be collimated with a low divergence in a compact installation space. Therefore, larger lenses are necessary to collimate beams from a beam source including a larger diffraction index and thus to achieve a low divergence of the beams.

Beamforming optical systems, for example, transmission units of LIDAR devices, are typically designed in such a way that they have the highest possible optical efficiency. For this purpose, the diameter of the optical unit has to be dimensioned sufficiently large to focus all beams of the beam source.

The radiant power implementable by surface emitters is proportional to the emission area of the surface emitter. For this reason, a compromise often results between the radiant power and the available installation space.

In the typical areas of application of LIDAR devices, the available installation space is limited and thus makes the use of powerful surface emitters difficult.

### SUMMARY

An object of the present invention is to provide a transmission unit and a LIDAR device which enable the use of powerful surface emitters with little installation space requirement.

This object may achieved with the aid of the present invention. Advantageous embodiments of the present invention are disclosed herein.

According to one aspect of the present invention, a transmission unit, in particular for a LIDAR device, for emitting collimated beams in a scanning area is provided.

In accordance with an example embodiment of the present invention, the transmission unit includes at least one beam source for generating beams in the form of a beam bundle. The beam source may preferably be designed as a surface emitter or an emitter array. Furthermore, the transmission unit includes a transmission optical unit including at least one lens. A diaphragm including at least one aperture is provided, which is configured to delimit a cross section of the beam bundle made up of the generated beams in a horizontal direction and/or a vertical direction. The at least one lens of the transmission optical unit is situated downstream from the diaphragm in the emission direction of the beams.

The beam bundle may be formed in one part or multiple parts. For example, a laser array may generate a multipart beam bundle, which may form a one-part beam bundle in the far field. The generated beams of the beam bundle do not have to extend in parallel to one another for this purpose. The beams of the beam bundle may only be aligned essentially in parallel to one another in collimated form.

The horizontal direction and the vertical direction are oriented orthogonally to a propagation direction of the beams.

A part of the generated beams of the beam source may be blocked or cut off by the use of the diaphragm. An edge section of the generated beams having a low radiant power may preferably be blocked to provide a reduced emission diameter or beam waist diameter.

The central main portion of the radiant power generated by the beam source may preferably pass through the diaphragm. The less powerful beams in the edge section may be blocked by the diaphragm.

The reduction of the emission diameter results in a lower diffraction index and a higher beam quality. A transmission optical unit including small dimensions may be used due to the higher beam quality and the reduced emission diameter. For example, the at least one lens may have a smaller diameter than the initial emission diameter of the beam source.

Moreover, a more homogeneous intensity distribution results due to the lateral blocking of the beams. The pupil of the human eye has, for example, a diameter of 7 mm. The highest energy which is incident on a circular area having 7 mm diameter is limiting in each case for the eye safety. If the emitted laser beam (after passing the diaphragm) has a significantly larger diameter than 7 mm, strong variations in the intensity are disadvantageous since higher energies in the intensity maxima may radiate into the eye.

The at least one lens of the transmission optical unit may preferably be used to collimate the beams which pass the diaphragm.

Preferably, 70%-95% of the beams generated by the beam source may be transmitted or pass through the diaphragm. The efficiency of the beam source may be slightly impaired by the use of the diaphragm in order to implement a compactly designed transmission unit.

According to a further aspect of the present invention, a LIDAR device for scanning a scanning area using beams is provided. The LIDAR device includes a transmission unit according to the present invention and a receiver unit for receiving beams reflected and/or backscattered from the scanning area.

The at least one beam source may enable, for example, a linear, round, or rectangular illumination using generated beams. In particular, the use of beam sources having an enlarged emission area, for example, surface emitters, with compact dimensions of the LIDAR device may be enabled. The at least one lens of the transmission optical unit may have a relatively large focal length of greater than 30 mm to collimate the generated beams transmitted through the diaphragm. Due to this measure, the beams are emitted having a low divergence into the scanning area.

Beams which are emitted at a large emission angle may preferably be blocked by the diaphragm. The large emission angle may be, for example, in the range of a maximum emission angle.

The emission diameter or at least a horizontal and/or vertical extension of the emitted beams, which significantly influence the installation space requirement of the LIDAR device, may be restricted by the diaphragm.

Depending on the design of the LIDAR device, multiple diaphragms may also be used. Alternatively or additionally, one diaphragm may include one or multiple apertures, through which the beams may pass the diaphragm. The shape and size of the at least one aperture may be set arbitrarily for this purpose to achieve an optimal beamforming and divergence.

The shape of the at least one aperture may preferably be adapted to an emission characteristic of the beam source.

The transmission unit is not restricted to one beam source. For example, multiple beam sources operated in parallel or in series may be used. The particular beam sources may each use separate apertures of the diaphragm. Alternatively, multiple beam sources may jointly expose one aperture of the diaphragm.

The beam source may be, for example, an LED or a laser. The generated beams may be generated in an infrared, ultraviolet, or visible wavelength range by the beam source.

According to one exemplary embodiment of the present invention, the lens of the transmission optical unit has a focal length which is configured to collimate the beams emitted from the diaphragm. The transmission optical unit may include one or multiple lenses which may collimate the generated beams transmitted through the diaphragm to form beams including lower divergence. The focal length of the lens may preferably be adapted to the arrangement of the beam source and the size of the aperture of the diaphragm.

The diaphragm may be integrated into the transmission optical unit. Alternatively, the transmission optical unit may be situated after a deflection mirror or a mirror element to form the generated beams which have passed the diaphragm for the emission into the scanning area.

The transmission optical units may additionally include filters and antireflective coatings to minimize scattered light or interference light.

According to another specific embodiment of the present invention, the at least one lens of the transmission optical unit has a focal length of at least 40 mm. By way of this measure, beams generated by the beam source at a large emission angle may also be collimated. The lens or the design of the transmission optical unit may preferably be adapted to the beam source to achieve a minimal divergence of the beams emitted into the scanning area.

According to another exemplary embodiment of the present invention, the aperture of the diaphragm has an extension in the horizontal direction and/or vertical direction by which an edge section of the beam bundle made up of the generated beams is blocked. The generated beams, and in particular the beam bundle made up of the generated beams, are absorbed by the diaphragm in the outermost edge section of the emission diameter and thus prevented from passing. The low energy portion of the generated beams of the beam source may be filtered by the use of the diaphragm in order to optimize the emission diameter of the beams for the following transmission optical unit. The transmission optical unit and in particular the at least one lens of the transmission optical unit may have smaller dimensions due to this measure.

The entire transmission unit may be manufactured having a smaller installation space requirement due to the possibility of a more compactly formed transmission optical unit.

According to another specific embodiment of the present invention, the edge section of the beam bundle made up of the generated beams which is blocked by the diaphragm has a portion of at least 10% of the total radiant energy of the generated beams. In this way, a significant reduction of the emission diameter of the generated beams may be achieved. The portion of the beams blocked by the diaphragm of the total radiant energy may preferably be 5%-30%. The beams which contribute slightly to the total radiant energy in the edge section are filtered by this measure. The radiant power provided by the beam source is thus only minimally reduced. However, a more compact structural form of the transmission unit may be enabled by the reduced emission diameter of the beams.

Alternatively or additionally, one or multiple optical elements may be provided to initially form the beams generated by the beam source.

In another specific embodiment of the present invention, at least regional lateral blocking of the generated beams by the diaphragm is provided to increase an eye safety limiting value. The lateral blocking of the beams relates to the constriction of a cross section of the beams transversely to the propagation direction of the beams. A more homogeneous intensity distribution may be implemented by the lateral blocking of the beams, which results in a higher eye safety limiting value.

According to another exemplary embodiment of the present invention, the generated beams have a linear cross section or a rectangular cross section, the generated beams having a greater extension in the vertical direction than in the horizontal direction. The beam source may thus include one or multiple emission areas which may emit the generated beams in arbitrary forms.

According to another specific embodiment of the present invention, the at least one aperture of the diaphragm has a round, oval, rectangular, square, or linear cross section. The at least one aperture of the diaphragm may have an arbitrary shape in this way to adapt the generated beams optimally in their emission diameter. Preferably, all generated beams, except for the beams in an edge section, may pass the aperture.

According to another exemplary embodiment of the present invention, the transmission unit includes a rotatable or pivotable mirror element downstream from the lens of the transmission optical unit or the diaphragm. Alternatively, the transmission unit is made rotatable or pivotable. The transmission unit may thus include a mirror element downstream from the diaphragm which may deflect the beams in different horizontal and/or vertical deflection angles after passing the diaphragm or after forming by the lens. The mirror element may, for example, execute a vertical and/or horizontal scanning movement to scan a scanning area using the emitted beams.

In an alternative embodiment of the present invention, the entire transmission unit may be situated on a rotatable or pivotable turntable to scan a horizontal extension of a scanning area using emitted beams. The vertical extension of the scanning area may be produced by an additional mirror element or by a vertically fanned-out shape of the emitted beams. For example, the generated beams may form a line shape which extends in the vertical direction.

The vertical fan-out of the generated beams may be carried out by one or multiple beam sources which emit linear beams. Alternatively or additionally, microlens arrays, macrolens arrays, cylinder lenses, and the like may be used to implement a vertical and/or horizontal fan-out of the generated beams.

Preferred exemplary embodiments of the present invention are explained in greater detail hereinafter on the basis of highly simplified schematic views.

### BRIEF DESCRIPTION OF THE DRAWINGS

FIG. 1 shows a schematic representation of a LIDAR device according to an exemplary embodiment of the present invention.

FIG. 2 shows a top view of a transmission unit of the LIDAR device from FIG. 1.

FIG. 3 shows a side view of a transmission unit of the LIDAR device from FIG. 1.

### DETAILED DESCRIPTION OF EXAMPLE EMBODIMENTS

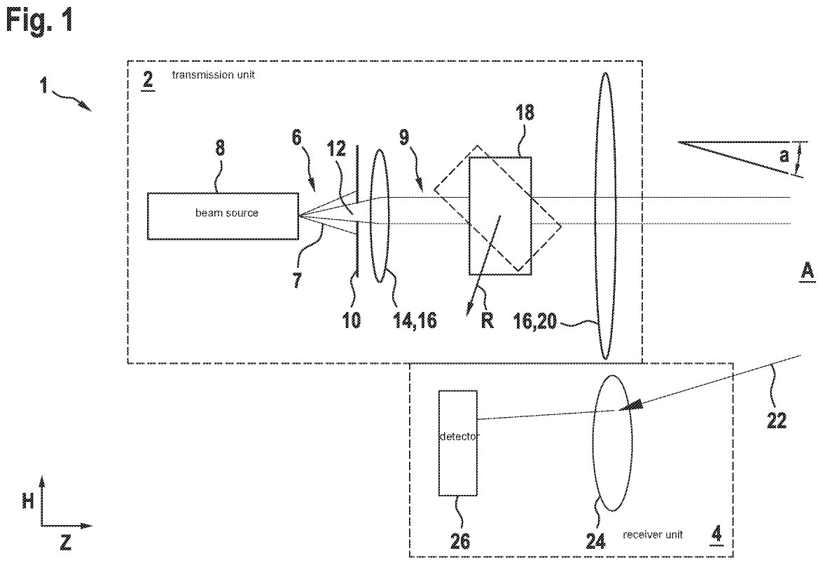

FIG. 1 shows a schematic representation of a LIDAR device 1 according to one exemplary embodiment. LIDAR device 1 is used to scan a scanning area A and includes a transmission unit 2 and a receiver unit 4.

Transmission unit 2 is configured to generate electromagnetic beams 6 and emit them at a varying scanning angle a into scanning area A.

For this purpose, transmission unit 2 includes a beam source 8 for generating electromagnetic beams 6. According to the exemplary embodiment, beam source 8 is designed as a semiconductor laser. Beam source 8 may be an arbitrary laser or an LED. Furthermore, beam source 8 may be designed as an array made up of a plurality of lasers and/or LEDs. For example, beam source 8 may be designed as a surface emitter.

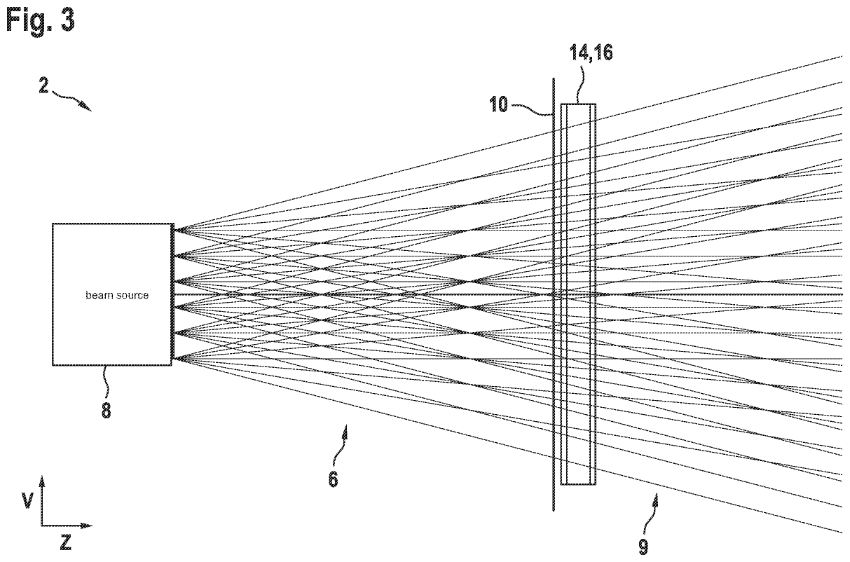

Beam source 8 includes an emission area extended in vertical direction V, by which generated beams 6 are generated in the form of a line. This is illustrated in FIG. 3. In horizontal direction H, the emission area of beam source 8 has an essentially punctiform extension.

Generated beams 6 may be, for example, in a wavelength range visible or invisible to the human eye, for example, the infrared range or UV range. Generated beams 6 are generated in the form of a one-part or multipart beam bundle by beam source 8.

The beam bundle made up of generated beams 6 is reduced in its cross section by a diaphragm 10. Diaphragm 10 includes an aperture 12, through which generated beams 6 may pass diaphragm 10. Beams in an edge section 7 of the beam bundle are blocked by diaphragm 10.

A lens 14 of a transmission optical unit 16 is connected downstream from diaphragm 10. Lens 14 is a convex lens which is usable, for example, to collimate generated beams 6. Beams 9 which have passed aperture 12 have a slightly lower radiant power since edge sections 7 of the beam bundle are blocked by diaphragm 10.

The beams which are collimated or at least preformed by lens 14 may subsequently be deflected by a mirror element 18 along an axis of rotation R.

Mirror element 18 may be designed, for example, as a cube prism, a mirror, a MEMS mirror, and the like.

The beams deflected by mirror element 18 may be formed by a further lens 20 of transmission optical unit 16 and subsequently emitted into scanning area A.

Generated beams 6 may be collimated by first lens 14, by second lens 20, or by a combination of both lenses 14, 20 of transmission optical unit 16.

Beams 22 which are backscattered or reflected in scanning area A are received by receiver unit 4 and detected. For this purpose, receiver unit 4 includes, for example, a receiver optical unit 24 and a detector 26.

Beams 22 detected by detector 26 of receiver unit 4 may subsequently be evaluated.

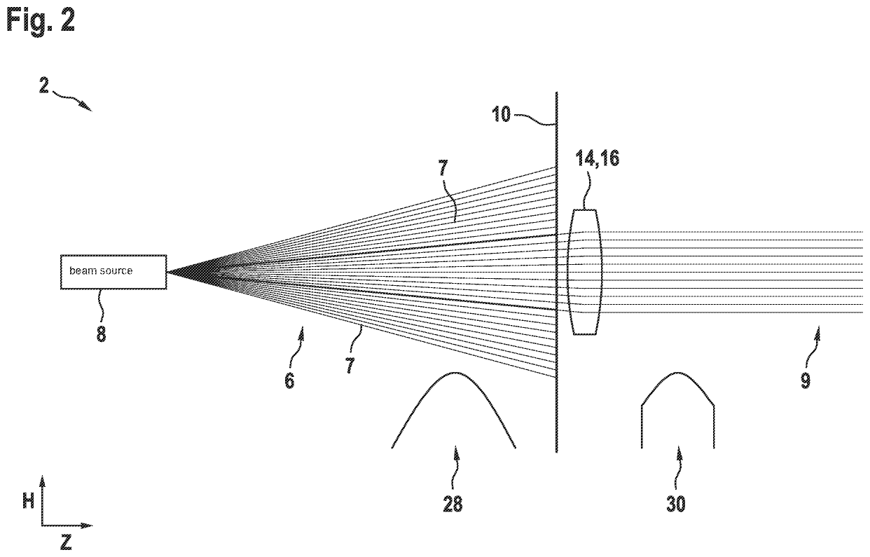

FIG. 2 shows a top view of transmission unit 2 of LIDAR device 1 from FIG. 1. In particular, the extension of generated beams 6 in horizontal direction H is illustrated. Diaphragm 10 delimits the beam bundle made up of generated beams 6 in horizontal direction H and blocks beams of edge section 7.

To illustrate the effect of the diaphragm, a beam profile 28 before diaphragm 10 and the beam profile 30 after diaphragm 10 are shown. Beam profiles 28, 30 describe a radiant energy along a cross section of generated beams 6 and beams 9 after passing diaphragm 10.

In the illustrated exemplary embodiment, beams 6 are exclusively delimited at the edge along horizontal direction H by diaphragm 10. In vertical direction V, for example, no blocking of beams 6 takes place due to diaphragm 10.

Diaphragm 10 and corresponding aperture 12 may be designed in such a way that beams 6 are blocked at the edge both in vertical direction V and in horizontal direction H.

FIG. 3 shows a side view of transmission unit 2 of LIDAR device 1 from FIG. 1 and illustrates the propagation of beams 6 in emission direction Z and along vertical direction V. It is illustrated that first lens 14 of transmission optical unit 16 is formed as a cylinder lens and generated beams 6 may pass in vertical direction V uninfluenced by the diaphragm.

Furthermore, it is illustrated by FIG. 3 that beam source 8 enables a linear illumination and an emission area extended in vertical direction V for emitting beams 6.

1-10. (canceled)

11. A transmission unit for a LIDAR device for emitting collimated beams into a scanning area, the transmission unit comprising:
at least one beam source configured to generate beams in the form of a beam bundle, the beam source being configured as a surface emitter or an emitter array;
a transmission optical unit including at least one lens; and
a diaphragm with at least one aperture, which is configured to delimit a cross section of the beam bundle made up of the generated beams in a horizontal direction and/or a vertical direction, the at least one lens of the transmission optical unit being situated downstream from the diaphragm in an emission direction of the beams.

12. The transmission unit as recited in claim 11, wherein the at least one lens of the transmission optical unit includes a focal length which is configured to collimate the beams exiting from the diaphragm.

13. The transmission unit as recited in claim 12, wherein the at least one lens of transmission optical unit has a focal length of at least 40 mm.

14. The transmission unit as recited in claim 11, wherein the aperture of the diaphragm has an extension in the horizontal direction and/or the vertical direction, by which an edge section of the beam bundle made up of the generated beams is blocked.

15. The transmission unit as recited in claim 14, wherein the edge section of the beam bundle made up of the generated beams which is blocked by the diaphragm includes a portion of at least 10% of a total radiant energy of the generated beams.

16. The transmission unit as recited in claim 11, wherein to increase an eye safety limiting value, at least regional lateral blocking of the generated beams by the diaphragm is provided.

17. The transmission unit as recited in claim 11, wherein the generated beams have a linear cross section or a rectangular cross section, the generated beams having a greater extension in the vertical direction than in the horizontal direction.

18. The transmission unit as recited in claim 11, wherein the at least one aperture of the diaphragm has a round cross section, or an oval cross section, or a rectangular cross section, or a square cross section, or a linear cross section.

19. The transmission unit as recited in claim 11, further comprising:
a rotatable or pivotable mirror element downstream from the at least one lens of the transmission optical unit or the diaphragm or the transmission unit, and the mirror is rotatable or pivotable.

20. A LIDAR device for scanning a scanning area using beams, comprising:
a transmission unit configured to emit collimated beams into the scanning area, including:
at least one beam source configured to generate beams in the form of a beam bundle, the beam source being configured as a surface emitter or an emitter array,
a transmission optical unit including at least one lens, and
a diaphragm with at least one aperture, which is configured to delimit a cross section of the beam bundle made up of the generated beams in a horizontal direction and/or a vertical direction, the at least one lens of the transmission optical unit being situated downstream from the diaphragm in an emission direction of the beams; and
a receiver unit configured to receive beams reflected and/or backscattered from the scanning area.
